(19) United States
(12) Patent Application Publication
(10) Pub. No.: US 2026/0354514 A1
(43) Pub. Date: Nov. 12, 2026

(54) System for forming a garment or accessory

(71) Applicant: Dariyadi Iskandar, Braddon (AU)

(72) Inventor: Dariyadi Iskandar, Braddon (AU)

(21) Appl. No.: 19/118,151

(22) PCT Filed: Oct. 5, 2022
(86) PCT No.: PCT/AU2022/051189

§ 371 Date: Apr. 3, 2025

(51) Int. Cl. A41D 31/00; A41D 3/00; A41D 13/05

(52) U.S. Cl. CPC A41D 31/0005; A41D 3/00; A41D 13/0556; A41D 2300/324

(57) ABSTRACT

A system for forming a garment or accessory, the system comprising modules which are interconnectable in multiple configurations whereby the garment or accessory comprises an assembly formed by interconnected modules of the system, wherein the modules comprise panels and connectors interengageable to interconnect the modules or panels, and wherein the modules comprise ones in each of which said connectors are arranged on opposite sides of the panel and aligned with one another.

### RELATED APPLICATIONS

The contents of Australian patent application no. 2021903185, filed 5 Oct. 2021, and Australian patent application no. 2022901336, filed 18 May 2022, each of which is entitled “System for forming a garment or accessory”, are incorporated herein by reference.

### FIELD OF THE INVENTION

The present invention relates to a system and method for forming a garment or accessory, to a garment or accessory formed via the system or method, and to a method of modifying such a garment or accessory.

### BACKGROUND

It is desirable that there be an ability to create, readily and easily, garments or accessories (including in particular clothing or fashion accessories or items of apparel) which vary, including in terms of, inter alia, type, appearance, shape, configuration and size according to the requirements of the person wearing the garment or using/carrying/wearing the accessory.

### SUMMARY OF THE INVENTION

The invention provides a system for forming a garment, accessory or the like (“garment or accessory”), the system comprising modules which are interconnectable whereby the garment or accessory is assembled therefrom.

Preferably, the modules are interconnectable in multiple configurations.

Preferably, the modules comprise panels and/or the modules include connectors interengageable to interconnect the modules or panels. Preferably the connectors comprise ones that are releasable interengageable. The connectors may, alternatively or additionally, comprise ones that are permanently interengageable.

In the preferred embodiments of the invention, the system is such that the garment or accessory comprises an assembly formed by interconnected modules of the system.

In the preferred embodiments of the invention, the modules comprise ones in each of which said connectors are arranged back-to-back on the panel and/or on opposite sides of the panel and aligned with one another.

According to a first aspect of the present invention, there is provided a system for forming a garment or accessory, the system comprising modules which are interconnectable in multiple configurations whereby the garment or accessory comprises an assembly formed by interconnected modules of the system, wherein the modules comprise panels and connectors interengageable to interconnect the modules or panels, and wherein the modules comprise ones in each of which said connectors are arranged on opposite sides of the panel and aligned with one another.

According to a second aspect of the present invention, there is provided a system for forming a garment or accessory, the system comprising modules which are interconnectable in multiple configurations whereby the garment or accessory comprises an assembly formed by interconnected modules of the system, wherein the modules comprise panels and connectors interengageable to interconnect the modules or panels, and wherein the modules comprise ones in each of which said connectors are arranged back-to-back.

Preferably, the connectors are arranged on the panels.

In a preferred embodiment of the invention, the modules comprise ones in which said connectors are affixed to the panels.

A preferred embodiment of the invention provides a kit comprising said system.

In preferred embodiments of the invention, the connectors arranged back-to-back are disposed at and/or on opposite sides of said panel.

Preferably, the modules comprise ones in each of which said connectors are arranged on opposite sides of the panel and aligned with one another.

Preferably, the connectors comprise bodies configured such that those of engaging ones of the connectors abut one another and/or define bases received against the panels to which the connectors comprising them are affixed.

In a preferred embodiment of the invention, the connectors aligned with one another are so aligned that a portion of the panel lies between said bodies thereof.

Preferably, the system comprises modules which are interconnectable in multiple configurations whereby the garment or accessory comprises an assembly formed by interconnected modules of the system

Preferably, the system comprises modules which are releasably interconnectable. The system may, alternatively or additionally, comprise modules which are permanently interconnectable.

Preferably, modules comprise ones arrangeable and/or interconnectable in overlapping and/or interleaving relation.

Preferably, the panels comprise ones that are flexible or pliable. Alternatively or additionally, the panels may comprise ones which are rigid.

The panels may comprise fabric or textile panels. Alternatively or additionally, the panels may comprise ones of other material, for example, plastic or polymeric material.

Preferably, the panels may comprise ones that are solid therethroughout and/or ones having one or more openings or apertures therethrough (e.g. mesh panels).

In a preferred embodiment of the invention, the panels comprise fabric panels that are flexible or pliable.

Preferably, the system comprises connectors that are riveted to the panels. Alternatively or additionally, the system may comprise connectors that are otherwise applied, e.g. stitched, to the panels.

Preferably, the system comprises connectors that are interengageable, mating or mateable and/or are configured to mate or engage one-with-another at variable angles in respective planes orthogonal to axes of the connectors or in planes of the panels where the connectors are disposed.

Preferably, the system comprises connectors that permit or allow for rotation of one module or panel relative to the other about axes of said connectors thereof or in planes of the panels thereof where the connectors are disposed, or about axes orthogonal to planes of the panels where the connectors are disposed when mating or interengaged.

Preferably, the system comprises connectors that comprise fasteners connectable one-to-another to interconnect respective modules. Said fasteners may comprise snap fasteners and/or press studs.

In a preferred embodiment of the system, the connectors comprise complementary first and second connectors. Preferably, the first and second connectors comprise male and female connectors respectively.

Preferably, the system comprises modules that comprise a plurality of first connectors. Preferably, the system comprises modules that comprise a plurality of second connectors, which may be connectable to said first connectors.

Preferably, the first and second connectors are arranged on opposite first and second sides of the modules or panels.

In preferred embodiments of the invention, the first connectors are different from (and may be complementary to) the second connectors.

Also possible are embodiments in which first connectors are interegageable or connectable one-to-another or and/or in which second connectors are interegageable or connectable one-to-another. The connectors in one such embodiment may, for example, comprise hermaphroditic connectors.

Preferably, the male connectors comprise bodies affixed to the panels and include protrusions, and the female connectors comprise bodies and openings, each opening being configured to receive a said protrusion such that the connectors comprising a said opening and a protrusion received thereby mate or are interengaged. Preferably, the female connectors include protrusions, projecting from or defined by the bodies thereof, through which said openings are formed.

Said openings and protrusions may be arranged such that when one of the former receives one(s) of the latter, the opening and the protrusion(s) received thereby are centred on a said axis whereby said swivelling or relative rotation is permitted.

In a preferred embodiment of the invention, a protrusion of a first connector and protrusion or body of a second connector comprise or are configured with complementary formations, preferably either comprising one or more radially outwardly protruding external circumferential protuberances (e.g. comprising ribs) and one or more radially inwardly opening interior circumferential recesses (e.g. comprising grooves) respectively, or comprising one or more radially inwardly protruding internal circumferential protuberances (e.g. comprising ribs) and one or more radially outwardly opening exterior circumferential recesses (e.g. comprising grooves) respectively.

Preferably, the second connectors comprise ones each of which has a cavity which opens through a distal end (e.g. of a protrusion or body) thereof, in which cavity the/each formation of the second connector is arranged and into which cavity a first connector of another module is matingly receivable such that the respective formation(s) of one connector receive the formation(s) of the other connector and the connectors are thus interengaged.

In a preferred embodiment of the invention, said protrusions of the first or male connectors are configured to be (preferably resiliently) deformed or flexed radially inwardly by the second or female connector (preferably by a said body or protrusion thereof) as the connectors are urged together, permitting the receipt of said formation(s) of one connector by said formation(s) of the other connector. Said first or male connectors may comprise ones each of which is configured with or comprises a cavity arranged to permit or facilitate the radially inward deformation or flexure of the protrusion thereof.

In a preferred embodiment of the invention, said second or female connectors comprise protrusions or bodies configured to be (preferably resiliently) deformed or flexed radially outwardly by the first or male connector (preferably by a said body or protrusion thereof) as the connectors are urged together, permitting the receipt of said formation(s) of one connector by said formation(s) of the other connector. Said second or female connectors may comprise ones each of which is configured with or comprises a cavity arranged to permit or facilitate the radially outward deformation or flexure of the protrusion or body thereof.

Preferably, the connectors comprise ones that are riveted to the panels and/or interconnected by riveting and/or applied whereby there is formed therebetween a rivet connection. Preferably, such connectors comprise said connectors on opposite sides of the panel and aligned with one another and/or arranged back-to-back.

In a preferred embodiment of the invention, one of the first/male or the second/female connectors comprise ones provided with a stem projecting therefrom which is received through an opening or hole with which the other of the first/male or the second/female connectors is provided, and a distal end of the stem is deformed, preferably by riveting, such that it engages said other connector to retain the (preferably back-to-back or aligned) indicators in engagement.

Preferably, the modules comprise ones each of which includes a connector component defining a respective connector provided with a stem, the connector component comprising that connector and the stem. Preferably, the connector component is formed of plastic or polymeric material.

Preferably, the connectors comprise ones formed of plastic or polymeric material.

Preferably, the system comprises modules each of which includes plural said connectors arranged at separate positions on the panel thereof for connection to respective other ones of the modules.

Preferably, the system comprises connectors that are arranged adjacent perimeters or perimeter edges of the panels. Preferably, the connectors are arranged at spaced positions around the panels. Preferably, these positions comprise regularly spaced positions.

Preferably, the system comprises panels or modules that comprise ones having straight and/or curved sides.

Preferably, the system comprises panels or modules that comprise polygonal ones.

Preferably, the system comprises panels or modules that comprise non-polygonal ones.

Preferably, the system comprises panels or modules that comprise ones of regular shape. The system may, alternatively or additionally, comprise panels or modules of irregular shape.

Preferably, the system comprises connectors that comprise ones arranged adjacent vertices of the shapes or panels.

Preferably, the system comprises modules or panels that vary in shape and/or in size and/or colour and/or in texture and/or in rigidity or flexibility/pliability and/or in other kind or type.

According to a third aspect of the present invention, there is provided a method of forming a garment or accessory, comprising interconnecting modules of the system, whereby the garment or accessory comprises an assembly formed by the interconnected modules.

According to a fourth aspect of the present invention, there is provided a garment or accessory comprising an assembly formed in accordance with said method and/or by interconnection of modules of the system.

According to a fifth aspect of the present invention, there is provided a said garment or accessory assembled by interconnection of modules of said system and/or comprising interconnected modules of said system.

The garment may comprise a jacket.

The garment may comprise a top.

The garment may comprise a dress.

Configuring modules such that first connectors and second connectors are arranged on one side and the other side, respectively, can facilitate interconnection of the modules and formation of the accessory garment.

In preferred embodiments of the present invention, the garment or accessory may comprise interconnected modules the first connectors of which are outward (relative to the respective panels of those modules and possibly also relative to the garment or accessory itself (i.e. exterior)) and the second connectors of which are inward (likewise relative to the respective panels of those modules and possibly also relative to the garment or accessory itself (i.e. interior)) or vice versa.

In a said garment or accessory, or in the formation thereof, according to preferred embodiments of the invention, there is formed an assembly comprising interconnected modules, in which first connectors are arranged at or toward one side and second connectors are arranged at or toward the other side, and in which one or more groups of first connectors or second connectors (which may comprise connectors of more than one of the modules thereof) may thus be arranged for connection, respectively, to one or more groups of second or first connectors, the latter group(s) possibly comprising at least one group of connectors of a single module and/or at least one group of connectors of another said assembly.

In a said garment or accessory, or in the formation thereof, according to preferred embodiments of the invention, modules or panels thereof—individually and/or of at least one said assembly—are arranged and/or interconnected in overlapping relation.

In a said garment or accessory, or in the formation thereof, according to preferred embodiments of the invention, modules or panels thereof—individually and/or of at least one said assembly—are arranged and/or interconnected in interleaved relation.

It is possible that at least one module (or panel thereof) overlaps one or more other modules (or panels thereof) and underlaps one or more other modules (or panels thereof) whereby first and second connectors of that module connect to second and first connectors of the overlapped and underlapped panels respectively or vice versa.

In a said garment or accessory, or in the formation thereof, according to preferred embodiments of the invention, modules, or connectors or panels (particularly portions thereof) thereof, can be interconnected in stacked or layered relation. More particularly, they may be connected one-to-another, via interconnected adjacent ones of back-to-back or opposed aligned connectors, to form stacks or layers comprising plural (e.g. two, three, four etc.) modules/connectors/panels/panel portions. The interengaged connectors at/in/of each stack can define a node or common position at which the modules comprising them are joined. Any one of the modules may be rotatable relative to the other(s) about the node/position.

In a said garment or accessory, or in the formation thereof, according to preferred embodiments of the invention, modules of differing type and/or kind—e.g. comprising modules or panels of differing colour and/or differing shape and/or differing texture and/or differing rigidity or flexibility/pliability—are arranged and/or interconnected.

A further advantage is an ability to modify a given garment or accessory by adding or removing one or more modules of the system—e.g. for aesthetic, fitting or climate—suitability purposes. For example, the system may include modules which can be arranged to overlap (e.g. underlap or overlap) and/or to interleave with (and connect to) at least one of the modules adjacent to and/or defining opening(s) in the garment or accessory.

According to a sixth aspect of the present invention, there is provided a method of modifying a said garment or accessory, comprising:
connecting, to at least one module of which the garment or accessory is comprised, one or more modules; and/or
disconnecting, from at least one module of which the garment or accessory is comprised, one or more modules.

In accordance with certain preferred embodiments of the invention, a said garment or accessory is designed to be carried or worn (typically by a person). The garment or accessory may comprise a carryable or wearable item.

### BRIEF DESCRIPTION OF THE DRAWINGS

Preferred embodiments of the invention are described, by way of non-limiting example, below, with reference to the accompanying drawings, in which:

FIG. 1 shows perspective views of a module of a system for forming a garment or accessory in accordance with a preferred embodiment of the invention, and a panel of such a module;

FIG. 2 shows cross-section views and a perspective view of modules, each of the type shown in FIG. 1, with the modules interconnected one-to-another in the perspective view and one of the cross-section views;

FIG. 3 shows perspective views of modules, each of the type shown in FIG. 1, interconnected one-to-another;

FIG. 4 shows perspective views of modules, each of the type shown in FIG. 1, and the process of connecting the modules into one of the configurations shown in FIG. 3;

FIG. 5 shows plan views of modules, each of the type shown in FIG. 1, interconnected one-to-another;

FIG. 6 shows plan views of modules comprising panels of varying shape in accordance with preferred embodiments of the present invention;

FIG. 7 shows plan views of modules comprising other panels of varying shape in accordance with preferred embodiments of the present invention;

FIG. 8 shows plan views of interconnected modules comprising panels of varying or constant/uniform shape in accordance with preferred embodiments of the present invention;

FIG. 9 shows plan views of interconnected modules comprising panels of varying shape in accordance with preferred embodiments of the present invention;

FIG. 10 shows plan views of interconnected modules comprising panels of constant/uniform or varying shape in accordance with preferred embodiments of the present invention;

FIG. 11 shows plan views of interconnected modules comprising panels of constant/uniform or varying shape in accordance with preferred embodiments of the present invention;

FIG. 12 shows front and back views of a jacket, exemplifying a garment, assembled by interconnection of modules of a system in accordance with a preferred embodiment of the invention;

FIG. 13 shows front and back views of a top, exemplifying another garment, assembled by interconnection of modules of a system in accordance with a preferred embodiment of the invention; and

FIG. 14 shows front and back views of a dress, exemplifying yet another garment, assembled by interconnection of modules of a system in accordance with a preferred embodiment of the invention.

### DETAILED DESCRIPTION OF THE PREFERRED EMBODIMENTS OF THE INVENTION

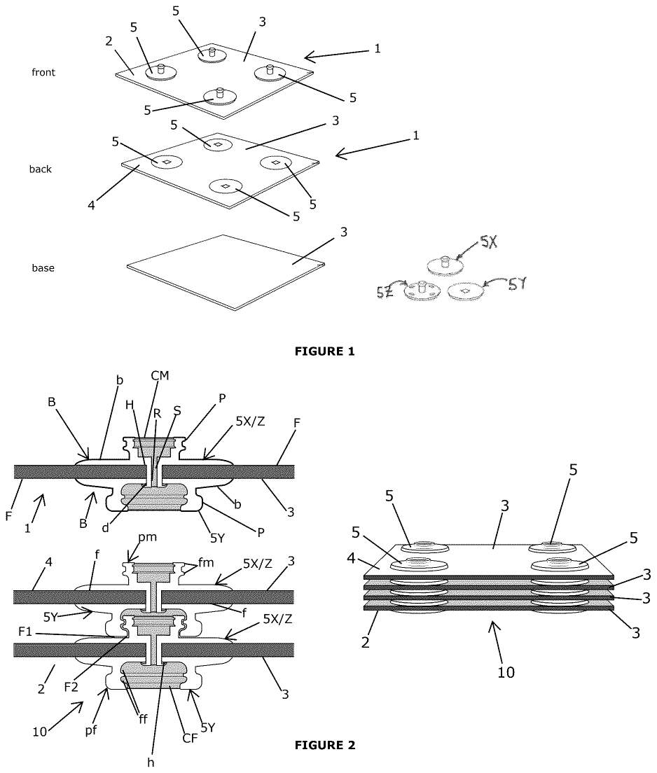

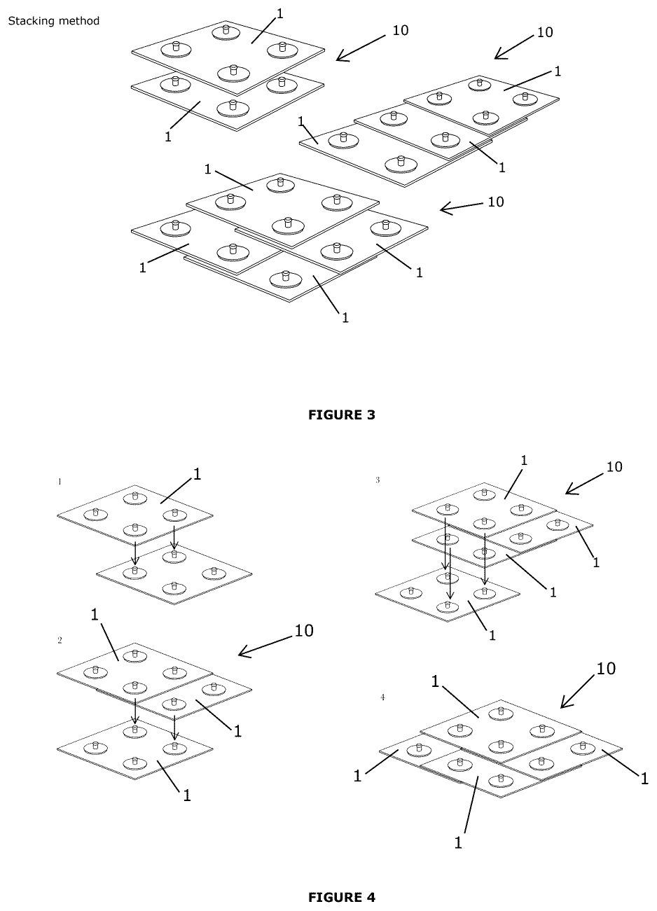

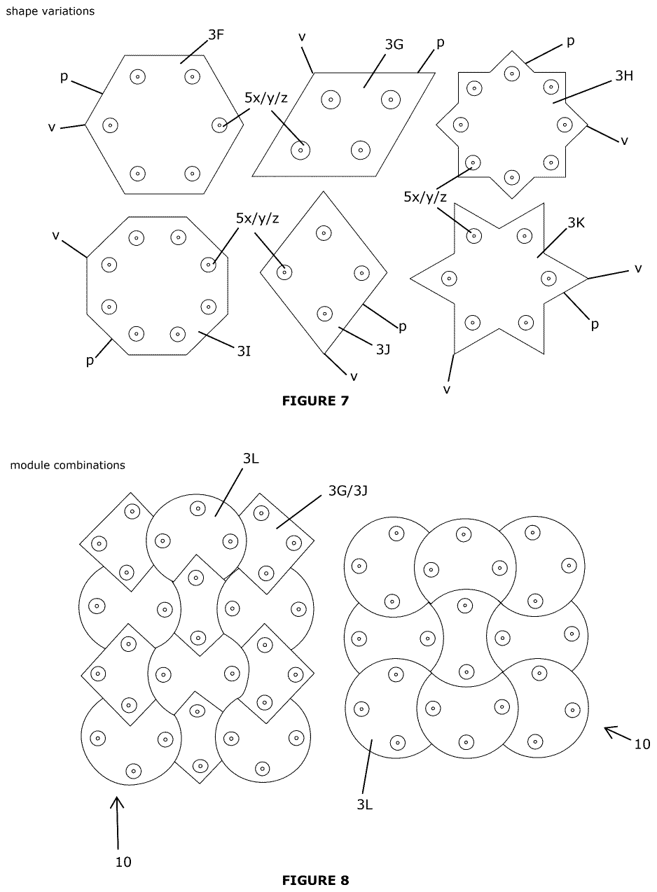

Shown in the drawings are systems 10 (see FIGS. 1 to 11) for forming a garment or accessory (see FIGS. 12 to 14) in accordance with particular preferred embodiments of the invention, the system comprising modules 1 which are releasably interconnectable in overlapping relation, in multiple configurations, whereby the garment or accessory 100 is assembled therefrom. Any one of the systems 10 may be provided in or as a kit.

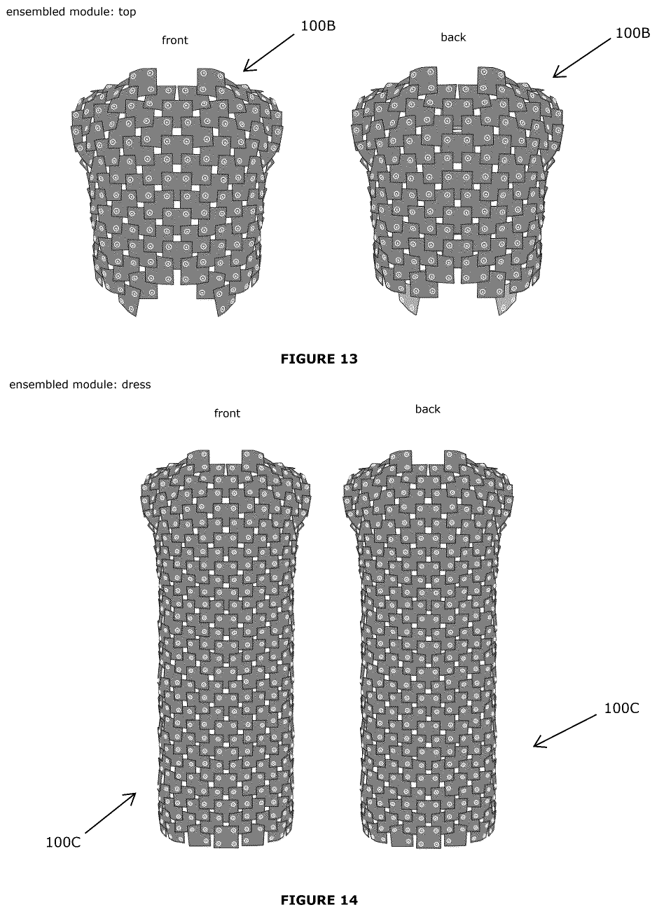

The garment 100 or accessory may comprise an assembly formed by interconnected modules 1 of the system 10. A given garment may, for instance, be a jacket 100A, an example of which is shown at FIG. 12, a top 100B, an example of which is shown at FIG. 13, or a dress 100C, an example of which is shown at FIG. 14.

The modules 1 have panels 3 and connectors 5 secured to the panels 3 and interengageable to interconnect the modules or panels, and comprise ones in each of which said connectors 5 are arranged on opposite sides of the panel 3 and aligned with one another and/or arranged back-to-back. The modules 1 may, alternatively or additionally, comprise ones in each of which said connectors 5 are arranged on only one side of the panel and/or ones in each of which said connectors 5 are arranged on opposite sides of the panel 3 though not back-to-back.

The panels 3 comprise ones which are flexible or pliable. The flexible or pliable panels 3 may comprise fabric panels. The panels 3 thus may be able to conform to the shape of the garment or accessory 100 (and in particular be able to flex to do so), as well as to the body of a wearer, and may be able to permit it to flex when worn or during donning or doffing thereof.

Alternatively or additionally, the panels 3 may comprise ones which are rigid and/or ones which made of material other than fabric.

The connectors 5 comprise mating or mateable connectors 5. The connectors 5 comprise ones configured to mate or engage one-with-another at variable angles in a plane parallel to planes of the panels 3. More particularly, the configuration of such connectors 5 is such that one of the interengaged connectors 5 can swivel or rotate relative to the other. The connectors 5 may thus permit or allow for rotation of one module 1 or panel 3 relative to the other about a central axis of either/each of the interengaged connectors 5, which is orthogonal to a plane of the panels 3 (where the connectors are arranged) when mating or interengaged.

The connectors according to the embodiment(s) described and illustrated comprise fasteners 5 connectable one-to-another to interconnect respective ones of said modules. The fasteners 5 comprise snap fasteners 5. The snap fasteners according to the embodiment(s) described and illustrated comprise, for example, dome fasteners, poppers or press studs.

The connectors may, alternatively or additionally, comprise other fasteners, for example hook-and-loop fasteners, without departure from the invention.

Referring to FIG. 2, the connectors 5 comprise ones each of which has a body B which defines a base b, having a face f arranged to be received against a face F of the panel 3, and a protrusion p arranged to project from the base b in a direction away from the face F. A (respective) portion of the panel 3 lies between the connectors 5/bodies B of a given back-to-back pair of such connectors.

The connectors 5 comprise complementary first 5X/Z and second 5Y connectors, which in the embodiments described and illustrated comprise male and female connectors respectively.

The modules 1 comprise ones each of which includes a plurality of said first connectors 5X/Z and/or of said second connectors 5Y.

The first 5X/Z and second 5Y connectors according to the embodiment(s) described and illustrated are arranged on opposite first 2 and second 4 sides, respectively, of the modules 1/panels 3.

The protrusion pm of the first connector 5X/Z and the protrusion pf or body B of the second connector 5Y are configured with complementary formations fm and ff, which in the said embodiments comprise one or more radially outwardly protruding external circumferential protuberances (e.g. comprising ribs, as shown) and one or more radially inwardly opening interior circumferential recesses (e.g. comprising grooves, as shown) respectively (but which may, for instance, instead comprise radially outwardly opening external circumferential recesses and radially inwardly protruding interior circumferential protuberances respectively, without departure from the invention). The second connector 5Y has a cavity CF which opens through a distal end (of the protrusion pf or body B) thereof, in which cavity the/each formation ff is arranged and into which cavity a first connector 5X/Z of another module 1 is matingly receivable such that the respective formation(s) ff of the second connector 5Y receive the formation(s) fm of the first connector 5X/Z and the connectors are thus interengaged. Either or each of the protrusions pm and pf is configured to be resiliently deformed or flexed radially (inwardly and outwardly respectively in the embodiments described and illustrated) by the other as the first 5X/Z and second 5Y connectors are urged together, permitting the receipt of formation(s) fm by formation(s) ff. Radial deformation of the protrusion pf may be permitted or facilitated by the cavity CF. Radial deformation of the protrusion pm may be permitted or facilitated by a cavity CM that first connector 5X/Z may include, which cavity may open through a distal end (of the protrusion pm or body B) thereof.

Also possible are embodiments of the invention in which female connectors do not include protrusions p and/or male connectors do not include cavities CM.

The connectors 5 comprise ones that are riveted to the panels 3. Referring to FIG. 2, the connectors 5 of each back-to-back connector pair are interconnected by riveting, whereby there is formed therebetween a rivet connection R. One of the connectors (the male connector 5X/Z in the embodiment described and illustrated) is provided with a stem S which projects from the body B, in a direction away from face f, thereof (i.e. in a direction opposite to that in which the protrusion p of that connector projects) and passes through (a hole H in) the panel 3 and a hole h (extending between face f and cavity CF) in base b of the other connector (the female connector 5Y in the embodiment described and illustrated). Formed at a distal end of the stem S, by a tool (not shown) used to effect the riveting (specifically, whereby a mandrel arranged to extend through the (hollow) stem S is drawn such that a head thereof is urged against the distal end) is a radially outwardly deformed portion d defining a retainer that engages the base b of the connector 5Y within the cavity CF to retain the back-to-back connectors 5X/Z and 5Y in engagement. It will, of course, be appreciated that it may be instead that the female connector 5Y is provided with the stem S and male connector 5X/Z formed with the hole h (extending between face f and cavity CM in base b thereof) without departure from the invention.

In the embodiment(s) described and illustrated, each connector (be it a first or second connector or a male or female connector) provided with a stem S is defined by a component comprising that connector and said stem.

In embodiments comprising one or more modules 1 in each of which there is at least one connector 5 not arranged back-to-back with another, there may be provided, to engage the connector 5, a retainer component comprising a base b, to be received against the opposite side of the panel 3, provided with a hole h therein (in the case that the connector 5 is of the kind provided with stem S) or comprising a stem S projecting therefrom (in the case that the connector 5 is of the kind including a hole h).

The connectors 5/connector components/retainer components in the embodiments described/illustrated are formed of polymeric material or plastic, though alternatively may be formed of alternative material, e.g. comprising metal.

The first 5X/Z and second 5Y connectors in the embodiments described and illustrated comprise opposable faces F1 and F2, which may be formed at a proximal portion of base b and a distal portion of protrusion pf (as shown), respectively, arranged to abut one another, to limit the proximity of the base b of one connector relative to the that of the other, when the connectors are interengaged. The faces F1 and F2 may be parallel to the faces f in the respective connectors.

With the protrusion pm (including the formation(s) fm) and cavity CF (including the formation(s) ff) being concentric about central axes of the connectors 5X/Z and 5Y respectively, the swivelling/rotation of one connector relative to the other, referred to above, when they are interconnected (in which case the abutment between faces F1 and F2 comprises rotational sliding abutment) is permitted. Although riveted connectors 5/connector components/retainer components, discussed above, are generally preferred—including owing to the ease of formation, and the reliability, of interconnections between each connector 5 and the respective panel 3 (and, in the case of back-to-back connectors, interconnections therebetween) which result—either of or both the first 5X/Z connectors and second 5Y connectors may instead or in addition comprise ones that are configured to be affixed or connected to or through the panels 3 in another manner—for instance, they may comprise holes to receive stitching for affixing them to panels 3 and/or to one another through the panels 3. Such holes are exemplified in the first connector 5Z.

The opposite sides 2, 4 may be arranged to be inwardly 2 and outwardly 4 facing respectively, or vice versa, in the garment or accessory 1.

The modules 1 in the embodiment(s) described and illustrated comprise ones each of which includes plural said connectors 5 arranged at separate positions on the panel 3 thereof for connection to respective other ones of the modules 1.

The panels 3 in the embodiment(s) described and illustrated, referring to FIGS. 1 to 11, comprise ones which vary in shape and/or in size.

The panels 3 may comprise ones of regular shape.

The panels 3 may comprise ones of irregular shape.

The panels 3 may comprise ones having straight and/or curved sides.

The panels 3 may comprise poly gonal ones 3A-3K.

The poly gonal panels may, for example, comprise any of simple, regular, irregular, convex, concave, equilateral, cyclic and equiangular polygonal panels.

The polygonal panels may comprise square and/or truncated-square panels 3A. The poly gonal panels may comprise triangular or trigonal and/or truncated-triangular or trigonal panels 3B. The poly gonal panels may comprise rectangular or rectagonal and/or truncated-rectangular or rectagonal panels 3C. The polygonal panels may comprise pentagonal and/or truncated-pentagonal panels 3D. The polygonal panels may comprise cross-shaped and/or plus-shaped panels 3E. The polygonal panels may comprise hexagonal and/or truncated-hexagonal panels 3F. The poly gonal panels may comprise parallelogram-shaped and/or truncated-parallelogram-shaped panels 3G. The polygonal panels may comprise star-shaped panels 3H, 3K. The polygonal panels may comprise octagonal and/or truncated-octagonal panels 3I. The poly gonal panels may comprise diamond-shaped and/or truncated-diamond-shaped panels 3J.

The panels 3 may comprise non-poly gonal ones 3L-3N.

The panels 3 may comprise circular panels 3L. The panels 3 may comprise semicircular and/or truncated-semicircular panels 3M. The panels 3 may comprise petal-shaped panels 3N.

The connectors 5 in the embodiment(s) described and illustrated comprise ones arranged adjacent perimeters or perimeter edges P of the panels 3.

The connectors 5 in the embodiment(s) described and illustrated comprise ones arranged at spaced positions around the panels 3. Said positions may comprise regularly spaced positions.

The connectors 5 according to the embodiment(s) described and illustrated comprise ones arranged adjacent vertices V of the shapes or panels 3.

The panels 3 may comprise ones which vary in colour and/or very in texture, individually and/or from one to another.

The panels 3 according to the embodiment(s) described and illustrated comprise ones which vary in size.

Referring to FIGS. 12 to 14, formation of a garment or accessory, exemplified as a jacket 100A, top 100B and dress 100C respectively in those drawings, comprises interconnecting modules 1 of the system 10, via connectors 5 thereof, whereby the garment or accessory 100 comprises said modules and/or is assembled therefrom.

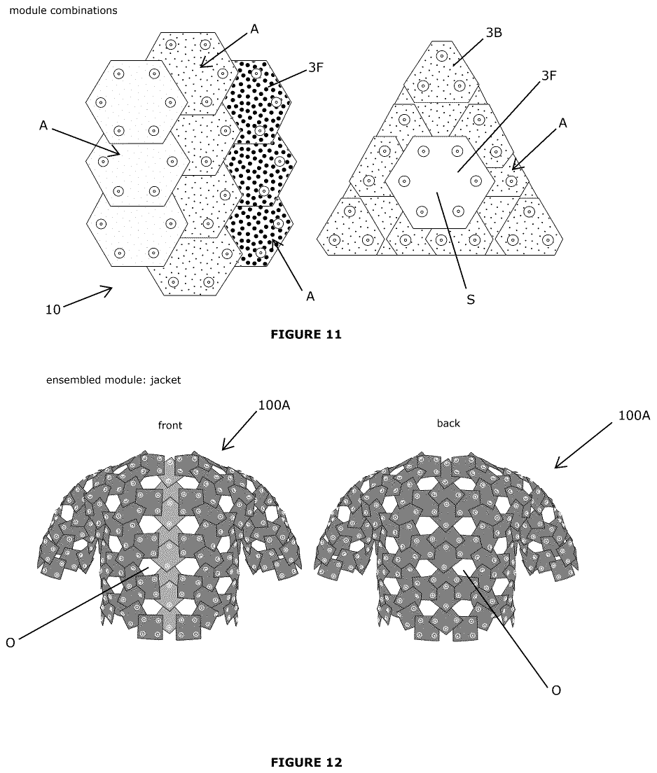

Advantageously, configuring modules 1 such that first connectors 5X/Z and the second connectors 5Y are arranged on one side and the other side, respectively, of panels 3, can facilitate interconnection of the modules 1 and formation of the garment 100. In particular, the garment 100 may comprise interconnected modules 1 the first connectors 5X/Z of which are outward (relative to the respective panels 3 of those modules 1 and possibly also relative to the garment 100 itself (i.e. exterior)) and the second connectors 5Y of which are inward (likewise relative to the respective panels 3 of those modules 1 and possibly also relative to the garment 100 itself (i.e. interior)) or vice versa. Referring (for instance) to FIGS. 10 and 11, at any stage in the construction/formation of a garment/accessory comprising the modules 1, an assembly A comprising interconnected modules 1 comprises connectors 5X/Z arranged are at or toward one side and connectors 5Y arranged are at or toward the other side. One or more groups of connectors 5X/Z and/or 5Y in an assembly A, which may in particular comprise connectors 5 of more than one of the modules 1 therein, may thus be arranged for connection to one or more (respective) groups of connectors 5Y and/or 5X/Z respectively, the latter group(s) possibly comprising at least one group of connectors of a single module S and/or at least one group of connectors of another assembly A (the modules/panels of respective assemblies A being shown patterned with small dots, medium dots and large dots for clarity or exemplification).

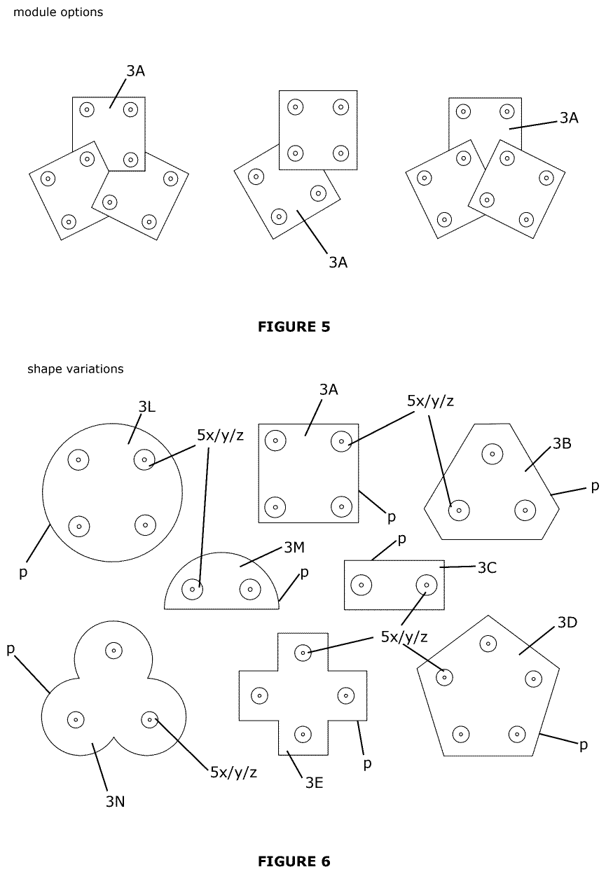

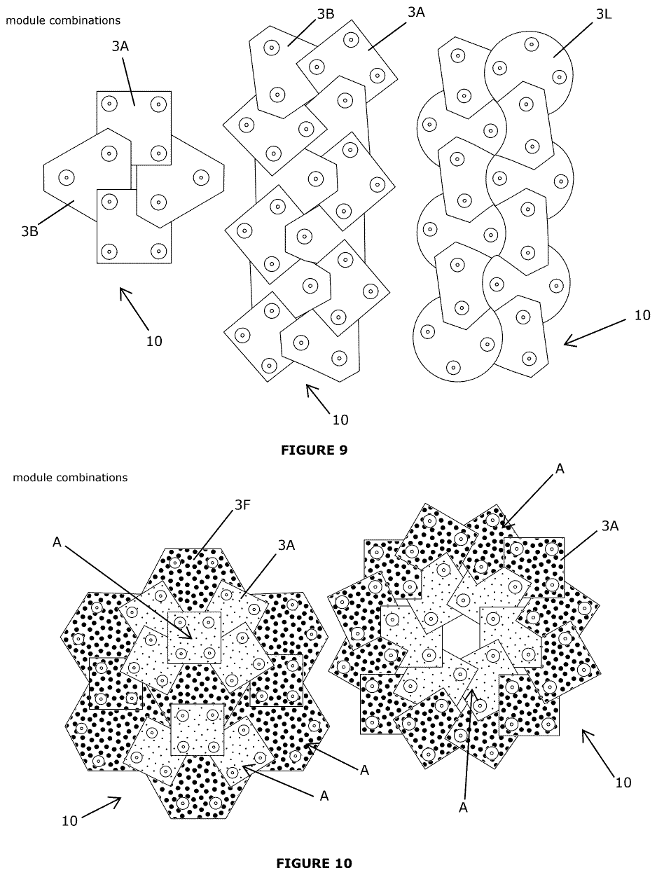

Advantageously, modules 1, individually or forming given assembly, and one or more other modules 1 (likewise individually or forming a given assembly) can be arranged in overlapping relation (which is exemplified in each of FIGS. 10 and 11, as well as all of the other drawings which show interconnected modules 1) and in interleaved relation (which is exemplified in particular in the arrangement on the right in FIG. 10, as well as in the arrangements on the left and right in FIG. 5, the arrangement on the left in FIG. 8, and the arrangements in FIG. 9), the latter being such that at least one panel 3 overlaps one or more other panels 3 and underlaps one or more other panels 3 whereby first and second connectors of that panel connect, respectively, to second and first connectors of the overlapped and underlapped panels or vice versa.

Also advantageous is that modules 1—or connectors 5, panels 3 or portions of panels 3 thereof—can be interconnected in stacked or layered relation (see in particular FIG. 2). More particularly, they may be interconnected one-to-another, via interconnected adjacent ones of back-to-back connectors, to form stacks or layers comprising plural (e.g. two, three, four etc.) modules/connectors/panels/panel portions. The interconnected connectors 5 at/in/of each stack can define a node or common position at which the modules 1 comprising them are joined. Any one of the modules 1 may be rotatable relative to the other(s) about the node/position, owing to the relative rotatability of connectors 5X/Z and 5Y when interengaged.

Additionally advantageous is that modules 1 of differing type can be assembled or interconnected. The modules 1 of differing type may comprise, inter alia, ones the panels of which are of differing shape (see, for example, FIGS. 8 to 11) and/or of differing colour or texture (see, for example, FIG. 12).

A further advantage is an ability to modify a given garment or accessory by adding or removing one or more modules 1 of the system-e.g. for aesthetic, fitting or climate-suitability purposes. For example, referring to FIG. 12 the system may include modules 1 which can be arranged to overlap (e.g. underlap or overlap) and/or to interleave with (and connect to) at least one of the modules 1 adjacent to and/or defining opening(s) O in the accessory/garment.

A said accessory may be for carrying and/or wearing. A said accessory may comprise, for example, a bag, hat or scarf.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. (canceled)

2. A system for forming a garment or accessory, the system comprising modules which are interconnectable in multiple configurations whereby the garment or accessory comprises an assembly formed by interconnected modules of the system, wherein the modules comprise panels and connectors interengageable to interconnect the modules or panels, and wherein the modules comprise ones in each of which said connectors are arranged back-to-back.

3. A system according to claim 2, wherein the connectors arranged back-to-back comprise ones disposed at and/or arranged on opposite sides of the panel.

4. A system according to claim 2, wherein the connectors comprises ones which are affixed to the panels.

5. A system according to claim 2, wherein the connectors comprise bodies configured such that those of engaging ones of the connectors abut one another and/or define bases received against the panels.

6. A system according to claim 2, wherein the connectors aligned with one another or arranged back-to-back are so aligned or arranged that a portion of the panel lies therebetween or between said bodies.

7. A system according to claim 2, wherein the modules comprise ones which are interconnectable in multiple configurations.

8. A system according to claim 2, wherein the modules comprise ones which are releasably interconnectable.

9-11. (canceled)

12. A system according to claim 2, wherein the connectors comprise ones which are stitched to the panels.

13. (canceled)

14. A system according to claim 2, wherein the connectors comprise ones configured to mate or engage one-with-another at variable angles in a plane of the panels or orthogonal to an axis of the connectors.

15. A system according to claim 2, wherein the connectors comprise ones permitting or allowing for rotation of one module or panel relative to the other about an axis of the connectors or an axis orthogonal to a plane of the panels when mating or interengaged.

16-18. (canceled)

19. A system according to claim 2, wherein the connectors comprise complementary first and second connectors.

20. A system according to claim 19, wherein the first and second connectors comprise male and female connectors respectively.

21-38. (canceled)

39. A method of forming a garment or accessory, comprising interconnecting modules of a system according to claim 2, whereby the garment or accessory comprises an assembly formed by the interconnected modules.

40. A garment or accessory which:
comprises an assembly formed by interconnection of modules of a system according to claim 2; and/or
is assembled by interconnection of modules of said system and/or comprises interconnected modules of said system.

41-43. (canceled)

44. A method according to claim 39, wherein there is formed an assembly comprising interconnected modules, in which first connectors are arranged at or toward one side and second connectors are arranged at or toward the other side, and in which one or more groups of first connectors or second connectors are thus arranged for connection, respectively, to one or more groups of second or first connectors.

45. A method according to claim 39, wherein modules, or connectors or panels or portions thereof, are interconnected in stacked or layered relation.

46. A method according to claim 45, wherein said modules or connectors or panels or portions thereof are connected one-to-another, via interconnected adjacent ones of back-to-back or opposed aligned connectors, to form stacks or layers comprising plural (e.g. two, three, four etc.) modules/connectors/panels/panel portions.

47. A method according to claim 46, wherein interengaged connectors at/in/of each stack define a node or common position at which the modules comprising them are joined.

48. A method according to claim 47, wherein, about at least one said node/position, at least one module is rotated or rotatable relative to at least one other module.

49. A method according to claim 39, wherein modules of differing type and/or kind—e.g. comprising modules or panels of differing colour and/or differing shape and/or differing texture and/or differing rigidity or flexibility/pliability—are arranged and/or interconnected.

50-52. (canceled)
